(19) United States
(12) Patent Application Publication
(10) Pub. No.: US 2015/0022514 A1
(43) Pub. Date: Jan. 22, 2015

(54) ORGANIC LIGHT EMITTING DISPLAY DEVICE

(71) Applicant: SAMSUNG DISPLAY CO., LTD., Yongin-City (KR)

(72) Inventors: Seung-Kyu LEE, Yongin-City (KR); Jin JEON, Yongin-City (KR); Mi-Hae KIM, Yongin-City (KR); Chang-Yeop KIM, Yongin-City (KR)

(21) Appl. No.: 14/329,167

(22) Filed: Jul. 11, 2014

(30) Foreign Application Priority Data
Jul. 18, 2013 (KR) 10-2013-0084475

(51) Int. Cl. G09G 3/36

(52) U.S. Cl. CPC G09G 3/3696
USPC 345/212

(57) ABSTRACT

An organic light emitting display device includes a plurality of pixels at areas defined by intersections of scan lines, emission control lines, and data lines. A data driver supplies data signals to the data lines. A scan driver supplies scan signals to the scan lines and progressively supplies a reference power source voltage and an emission control signal to the emission control lines. The reference power source voltage is set to a voltage greater than a voltage of the scan signal and less than a voltage of the emission control signal.

### CROSS-REFERENCE TO RELATED APPLICATION

Korean Patent Application No. 10-2013-0084475, filed on Jul. 18, 2013, and entitled, “Organic Light Emitting Display Device,” is incorporated by reference herein in its entirety.

### BACKGROUND

1. Field

One or more embodiments described herein relate to a display device.

2. Description of the Related Art

The performance of displays must increase as information technology evolves. Flat panel displays have been developed in pursuit of this goal. One type of flat panel display, known as an organic light emitting diode (OLED) display, has pixels which output light based on a recombination of electrons and holes in corresponding active layers. Displays of this type have demonstrated relatively fast response speed, low-voltage driving and power consumption, and excellent viewing angle.

### SUMMARY

In accordance with one embodiment, an organic light emitting display device includes a plurality of pixels at areas defined by intersections of scan lines, emission control lines, and data lines; a data driver to supply data signals to the data lines; and a scan driver to supply scan signals to the scan lines, and to progressively supply a reference power source voltage and an emission control signal to the emission control lines, the reference power source voltage set to a voltage greater than a voltage of the scan signal and less than a voltage of the emission control signal.

Each pixel may include a plurality of transistors to receive the reference power source voltage from the scan driver, wherein the reference power source is to provide a voltage at a level to turn on a first transistor and to turn off a second transistor.

The scan driver may progressively supply the scan signal to the scan lines, the scan driver may supply the reference power source voltage to a j-th emission control line to overlap the scan signal supplied to a (j−1)-th scan line during a first period, and the scan driver may supply the emission control signal to the j-th emission control line to overlap the scan signal supplied to the (j−1)-th scan line and the scan signal supplied to a j-th scan line during a second period which does not overlap the first period.

The scan driver may include a plurality of control transistors coupled to respective ones of the emission control lines, and each control transistor may supply the reference power source voltage to a respective emission control line based on a control signal.

Each pixel positioned on a j-th horizontal line of the display device may includes an organic light emitting diode (OLED), a first transistor to control an amount of current flowing from a first power source coupled through a first node to a second power source via the OLED, corresponding to a voltage applied to a second node, a fifth transistor coupled between the first power source and the first node, the fifth transistor having a gate electrode coupled to a j-th emission control line; and a sixth transistor coupled between a second electrode of the first transistor and an anode electrode of the OLED, the sixth transistor having a gate electrode coupled to the j-th emission control line.

The fifth transistor may turn on when the reference power source voltage is supplied to the j-th emission control line, and the sixth transistor may turn off when the reference power source voltage is supplied to the j-th emission control line. The fifth and sixth transistors may turn off when the emission control signal is supplied to the j-th emission control line.

Each pixel may include a second transistor coupled between the second node and an initialization power source, the second transistor to turn on when the scan signal is supplied to a (j−1)-th scan line; a third transistor coupled between the second electrode of the first transistor and the second node, the third transistor to turn on when the scan signal is supplied to a j-th scan line; and a fourth transistor coupled between a data line and the first node, the fourth transistor to turn on when the scan signal is supplied to the j-th scan line. The initialization power source may be set to a voltage lower than a voltage of the data signal.

Each pixel may include a seventh transistor coupled between the anode electrode of the OLED and the initialization power source, the seventh transistor to turn on when the scan signal is supplied to a (j+1)-th scan line. The scan signal supplied to the (j+1)-th scan line may overlap the emission control signal supplied to the j-th emission control line.

In accordance with another embodiment, a pixel circuit includes a first transistor coupled to a first power source; and a second transistor coupled to a second power source, wherein the first and second transistors are to turn on during a first period to initialize a driving transistor coupled to control an organic light emitting diode (OLED), the first transistor to turn on based on a first value of an emission control line and the second transistor is to turn on based on a first scan signal of another pixel circuit.

The pixel circuit may include a third transistor between the driving transistor and OLED, wherein third transistor is to turn off based on the first value of the emission control line which is to turn on the first transistor during the first period. The first transistor and the third transistor may have a same conductivity type. The first transistor may turn on and the third transistor may turn off based on the first value of the emission control line based on a coupling of the first transistor to the first power source during the first period.

The first and second transistors may turn on to initialize the driving transistor before a data signal is received. The first scan signal may not overlap a second scan signal applied to diode-connect the driving transistor. The first transistor may turn off based on a second value of the emission control line applied during a second period which does not overlap the first period. The emission control line may have the second value at a same time the first scan signal is applied to the other pixel circuit. A storage capacitor may be coupled between the first power source and the second transistor.

### BRIEF DESCRIPTION OF THE DRAWINGS

Features will become apparent to those of skill in the art by describing in detail exemplary embodiments with reference to the attached drawings in which:

FIG. 1 illustrates an embodiment of an organic light emitting display device;

FIG. 2 illustrates an embodiment of a pixel in the display device;

FIG. 3 illustrates an embodiment of a method for driving the pixel; and

FIG. 4 illustrates an embodiment of a scan driver.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

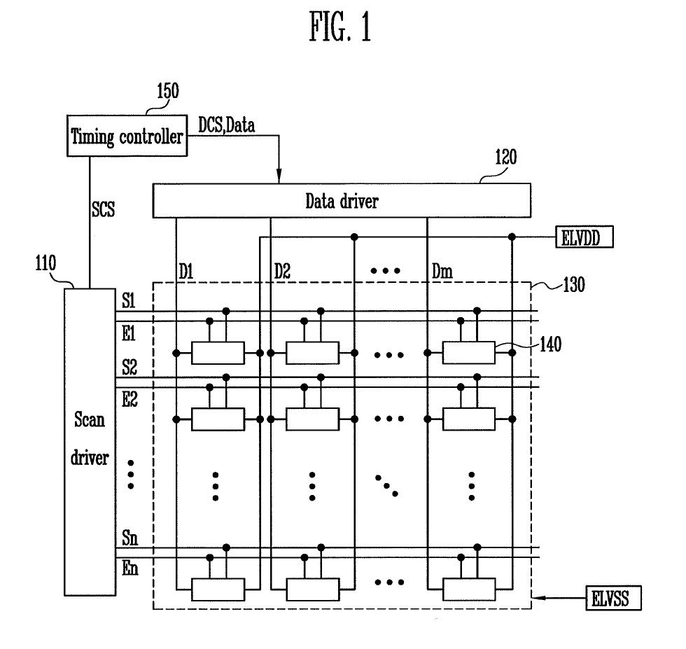

FIG. 1 illustrates an embodiment of an organic light emitting display device which includes a scan driver 110, a data driver 120, and a pixel unit 130. The pixel unit 130 includes a plurality of pixels 140 located in an area defined by scan lines S1 to Sn and data lines D1 to Dm. The scan driver 110 drives the scan lines S1 to Sn and emission control lines E1 to En. The data driver drives the data lines D1 to Dm. A timing controller 150 controls the scan driver 110 and the data driver 120.

The timing controller 150 generates a data driving control signal DCS and a scan driving control signal SCS. These signals may be generated based on one or more synchronization signals supplied from an external source. The data driving control signal DCS is supplied to the data driver 120, and the scan driving control signal SCS is supplied to the scan driver 110. The timing controller 150 also supplies data Data to the data driver 120. The data may be supplied from an external source.

The scan driver 110 generates scan signals (e.g., a low voltage) based on the scan driving control signal SCS from the timing controller 150. The scan signals are supplied to the scan lines S1 to Sn. Also, the scan driver 110 progressively supplies a reference power source and an emission control signal (e.g., a high voltage) to each of the emission control lines E1 to En, in response to the scan driving control signal SCS.

In one embodiment, the width of the emission control signal is set to be equal to or greater than a width of the scan signal. Also, the emission control signal supplied to an i-th (i is a natural number) emission control line Ei may partially overlap the scan signal supplied to an (i−1)-th scan line Si−1 during a second period. The emission control signal supplied to the i-th emission control line Ei may completely overlap the scan signal supplied to an i-th scan line Si. In other embodiments, the width of the emission control line may be set differently, for example, based on the circuit structure of the pixels 140.

Additionally, the voltage of the reference power source supplied to the i-th emission control line Ei may overlap the scan signal supplied to the (i−1)-th scan line Si−1 during a first period. When the voltage of the reference power source is supplied to the emission control line Ei, an on-bias voltage is applied to a driving transistor in each pixel 140 during the first period. In one embodiment, the voltage of the reference power source may be set to be lower than the emission control signal and higher than the scan signal, as will be described in greater detail below.

The data driver 120 generates data signals based on the data driving control signal DCS from the timing controller 150. The data signals are supplied to the data lines D1 to Dm, for example, in synchronization with the scan signal.

The pixels 140 are located in areas defined by intersections of the scan lines S1 to Sn and data lines D1 to Dm. The pixels 140 receive a first power source ELVDD and a second power source ELVSS. The second power source ELVSS may be set to a voltage lower than the first power source ELVDD. The power sources may be supplied from an external source.

Each pixel 140 includes a driving transistor and an organic light emitting diode (OLED). The driving transistor controls the amount of current flowing from the first power source ELVDD to the second power source ELVSS via the OLED based on the data signal. The OLED emits light with a predetermined luminance based on the amount of current from the driving transistor.

In the present embodiment, the pixel 140 coupled to the i-th horizontal line is shown as being coupled to the i-th scan line Si. However, in other embodiments, the pixel 140 coupled to the i-th horizontal line may additionally, or alternatively, be coupled to scan line Si−1 located on a previous horizontal line and/or a scan line Si+1 positioned on a next horizontal line.

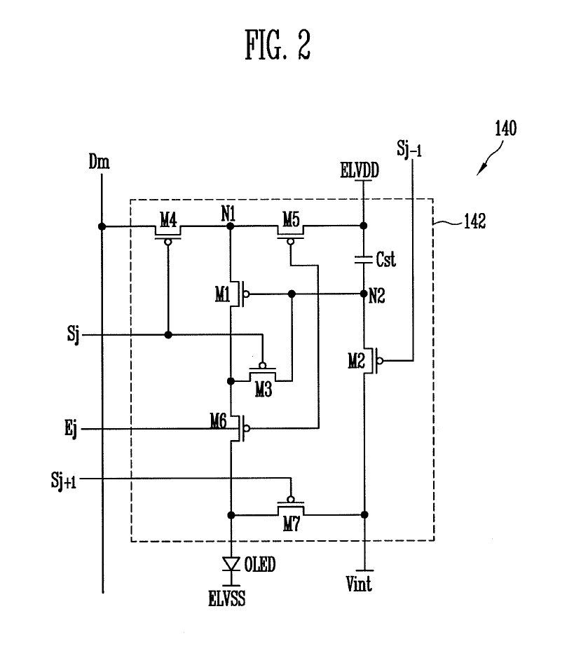

FIG. 2 illustrates an embodiment of a pixel, which, for example, may be included in the display device of FIG. 1. For convenience of illustration, the pixel in FIG. 2 is one coupled to an m-th data line Dm and positioned on a j-th (j is a natural number) horizontal line.

Referring to FIG. 2, pixel 140 includes a pixel circuit 142 configured to control the amount of current supplied to the OLED. The OLED generates with a predetermined luminance corresponding to the amount of current supplied from the pixel circuit 142. The pixel circuit 142 controls the amount of the current supplied to the organic light emitting diode OLED, in correspondence with a scan signal.

The pixel circuit 142 includes first to seventh transistors M1 to M7 and a storage capacitor Cst. A first electrode of the fourth transistor M4 is coupled to the data line Dm. A second electrode of the fourth transistor M4 is coupled to a first node N1. A gate electrode of the fourth transistor M4 is coupled to a j-th scan line Sj. The fourth transistor M4 is turned on when a scan signal is supplied to the j-th scan line Sj, to supply the data signal from the data line Dm to the first node N1.

A first electrode of the first transistor (driving transistor) M1 is coupled to the first node N1. A second electrode of the first transistor M1 is coupled to a first electrode of the sixth transistor M6. A gate electrode of the first transistor M1 is coupled to a second node N2. The first transistor M1 controls the amount of current flowing from the first power source ELVDD to the second power source ELVSS through the OLED, corresponding to a voltage applied to the second node N2.

A first electrode of the second transistor M2 is coupled to the second node N2. A second electrode of the second transistor M2 is coupled to an initialization power source Vint. A gate electrode of the second transistor M2 is coupled to a (j−1)-th scan line Sj−1. The second transistor M2 is turned on when the scan signal is supplied to the (j−1)-th scan line, to supply the voltage of the initialization power source Vint to the second node N2. In one embodiment, the initialization power source Vint is set to a voltage lower than the data signal.

A first electrode of the third transistor M3 is coupled to the second electrode of the first transistor M1. A second electrode of the third transistor M3 is coupled to the second node N2. A gate electrode of the third transistor M3 is coupled to the j-th scan line Sj. The third transistor M3 is turned on when the scan signal is supplied to the j-th scan line Sj, to allow the first transistor M1 to be diode-coupled.

A first electrode of the fifth transistor M5 is coupled to the first power source ELVDD. A second electrode of the fifth transistor M5 is coupled to the first node N1. A gate electrode of the fifth transistor M5 is coupled to an emission control line Ej. The fifth transistor M5 is turned off when an emission control signal is supplied to the emission control line Ej, and is turned on when the emission control signal is not supplied. Additionally, the fifth transistor M5 is set in the turn-on state when a reference voltage is supplied to the emission control line Ej.

The first electrode of the sixth transistor M6 is coupled to the second electrode of the first transistor M1. A second electrode of the sixth transistor M6 is coupled to an anode electrode of the OLED. A gate electrode of the sixth transistor M6 is coupled to the emission control line Ej. The sixth transistor M6 is turned off when the emission control signal is supplied to the emission control line Ej, and is turned on when the emission control signal is not supplied. Additionally, the sixth transistor M6 is set in the turn-off state when the voltage of the reference power source is supplied to the emission control line Ej.

The seventh transistor M7 is coupled between the anode electrode of the OLED and the initialization power source Vint. A gate electrode of the seventh transistor M7 is coupled to the (j+1)-th scan line Sj+1. The seventh transistor M7 provides a leakage path through which a predetermined current can flow from the anode electrode of the OLED to the initialization power source Vint. Accordingly, it is possible to enhance black expression performance. While the seventh transistor M7 is added to enhance the black expression performance, in other embodiments transistor M7 may be omitted depending, for example, on the structure of the pixel 140.

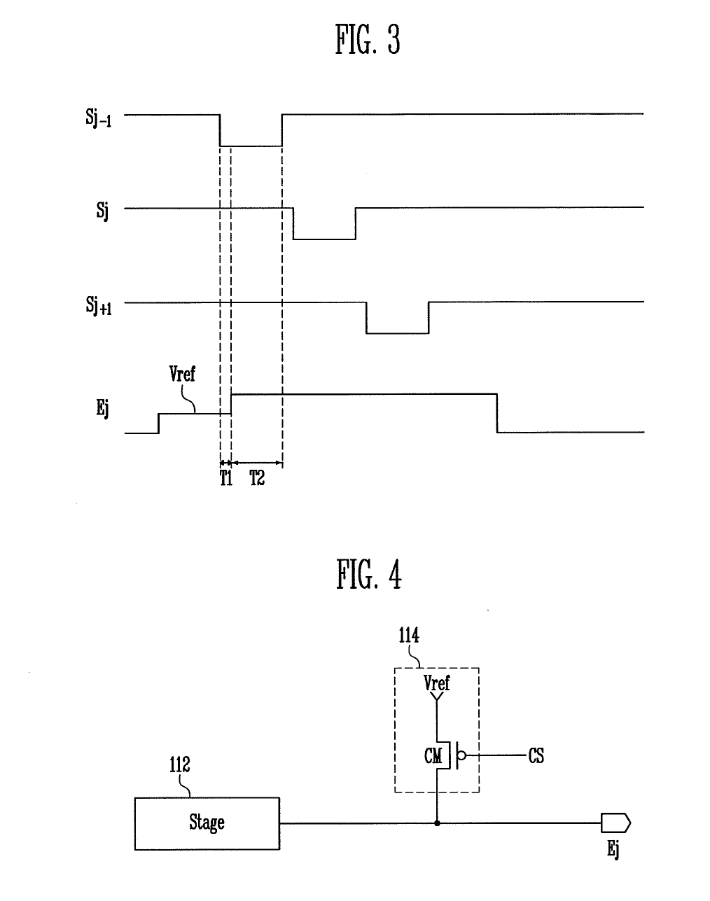

FIG. 3 illustrates one embodiment of a method for driving the pixel in FIG. 2. An initial operation of this method includes supplying the voltage of a reference power source Vref to the emission control line Ej. When the voltage of the reference power source Vref is supplied, the fifth transistor M5 is turned on and the sixth transistor M6 is turned off.

Specifically, the voltage of the first power source ELVDD is applied to the first electrode (source electrode) of the fifth transistor M5 during a period in which pixel 140 emits light. In addition, a voltage lower than that of the first power source ELVDD is applied to the first electrode of the sixth transistor M6 by resistance components of the fifth and first transistors M5 and M1 during the period in which pixel 140 emits light.

The reference power source Vref is set to a voltage at which the transistor is turned on when the voltage of the first power source ELVDD is applied to the first electrode thereof, and is turned off when a voltage lower than that of the first power source ELVDD is applied to the first electrode thereof. Thus, during the period in which the voltage of the reference power source Vref is supplied to the emission control line Ej, the fifth transistor M5 is turned on and the sixth transistor M6 is turned off The voltage of the reference power source Vref may be a predetermined voltage set, for example, based on an intended application, or may be experimentally determined taking into consideration, for example, one or more parameters of the panel, e.g., panel resolution, resistance components of transistors, etc.

When the fifth transistor M5 is turned on, the voltage of the first power source ELVDD is supplied to the first node N1. Because the sixth transistor M6 is turned off at this time, the OLED and first transistor M1 are electrically decoupled from each other. Accordingly, the OLED is set in a non-emission state.

Subsequently, the scan signal is supplied to the (j−1)-th scan line Sj−1. When the scan signal is supplied to the (j−1)-th scan line Sj−1, the second transistor M2 is turned on. When the second transistor M2 is turned on, the voltage of the initialization power source Vint is supplied to the second node N2. The voltage of the reference power source Vref is supplied to the emission control line Ej during a first period T1, in the period in which the scan signal is supplied to the (j−1)-th scan line Sj−1.

Thus, during the first period T1, the voltage of the first power source ELVDD is supplied to the first node N1, and the voltage of the initialization power source Vint is supplied to the second node N2. In this case, an on-bias voltage is applied to the first transistor M1, so that the threshold voltage of the first transistor M1 is initialized in a certain state.

That is, in the present embodiment, the characteristic of the second transistor M2 is initialized in the on-bias state. Accordingly, it is possible to display an image with a desired luminance irrespective of a data signal in the previous period. Additionally, in the present embodiment, the first transistor M1 is initialized by supplying the voltage of the reference power source Vref to the emission control line Ej without having to add a separate transistor.

The emission control signal is supplied to the emission control line Ej during a second period T2, in the period in which the scan signal is supplied to the (j−1)-th scan line Sj−1. When the emission control signal is supplied to the emission control line Ej, the fifth and sixth transistors M5 and M6 are set in the turn-off state.

After the emission control signal is supplied to the emission control line Ej, the scan signal is supplied to the j-th scan line Sj. When the scan signal is supplied to the j-th scan line Sj, the third and fourth transistors M3 and M4 are turned on.

When the third transistor M3 is turned on, the first transistor M1 is diode-coupled. When the fourth transistor M4 is turned on, the data signal from the data line Dm is supplied to the first node N1. In this case, the second node N2 is initialized with the voltage of the initialization power source Vref. As a result, the first transistor M1 is turned on.

When the first transistor Ml is turned on, the voltage obtained by subtracting the threshold voltage of the first transistor M1 from the voltage of the data signal is applied to the second node N2. The storage capacitor Cst stores the voltage applied to the second node N2.

After a predetermined voltage is charged in storage capacitor Cst, the scan signal is supplied to the (j+1)-th scan line Sj+1. When the scan signal is supplied to the (j+1)-th scan line Sj+1, the initialization power source Vint and the anode electrode of the OLED are electrically coupled to each other. In this case, the voltage charged in a parasitic capacitor equivalently formed in the OLED is discharged.

Subsequently, supply of the emission control signal to the emission control line Ej is stopped, so that the fifth and sixth transistors M5 and M6 are turned on. When the fifth and sixth transistors M5 and M6 are turned on, a current path is formed from the first power source ELVDD to the second power source ELVSS through the OLED. The first transistor M1 controls the amount of current flowing from the first power source ELVDD to the organic light emitting diode OLED, based on the voltage stored in the storage capacitor Cst.

When pixel 140 expresses a predetermined range of gray scale values (e.g., black), a fine current may be supplied from the pixel circuit 142 to the OLED. In this case, the parasitic capacitor equivalently formed in the OLED is discharged. As a result, the OLED can be stably maintained in the non-emission state. A portion of the fine current may be supplied to the initialization power source Vint by the leakage current formed by the seventh transistor M7. Accordingly, it is possible to prevent the OLED from emitting light.

FIG. 4 illustrates an embodiment of a scan driver, which, for example, may correspond to scan driver 110 in FIG. For convenience of illustration, only one channel is shown in FIG. 4 for purposes of illustrating the operation of the scan driver.

Referring to FIG. 4, the scan driver includes a stage 112 and a supply unit 114. The stage 112 supplies an emission control signal, and supply unit 114 supplies a reference power source Vref. Moreover, the stage 112 is positioned for each channel of the scan driver, and supplies the emission control signal to an emission control line Ej.

The supply unit 114 is coupled to each of the emission control lines E1 to En. The supply unit 114 supplies the voltage of the reference power source Vref to the emission control line Ej based on a control signal CS applied to the gate of a control transistor CM.

The control transistor CM is located between the reference power source Vref and the emission control line Ej. Moreover, the control transistor CM is turned on when the control signal CS is supplied, to supply the voltage of the reference power source Vref to the emission control line Ej. The signal obtained by delaying a scan signal from the previous stage may be used as the control signal CS.

For example, a scan signal supplied to a (j−2)-th scan line Sj−2 may be supplied as the control signal CS to the control transistor CM coupled to the emission control line Ej. However, the signal obtained by delaying the scan signal supplied to the (j−2)-th scan line Sj−2 for a certain period is supplied as the control signal CS. The delay allows the voltage of the reference power source Vref to overlap the scan signal supplied to the (j−1)-th scan line Sj−1 during the first period, as shown in FIG. 3.

Although the aforementioned embodiments have been described for a pixel circuit that uses PMOS transistors, NMOS transistors may be used for the pixel circuit in other embodiments. Also, the OLED may generate red, green or blue light based on the amount of current supplied from the driving transistor. Alternatively, the OLED may generate white light based on the amount of current supplied from the driving transistor. When the OLED generates white light, a color image may be implemented using a separate color filter or the like.

By way of summation and review, an organic light emitting display device includes a plurality of pixels arranged in a matrix form at intersection portions of a plurality of data lines, scan lines and power lines. Each pixel may include a driving transistor configured to control the amount of current flowing through an OLED. The pixel generates light with a predetermined luminance based on the amount of current from the driving transistor, which amount of current corresponds to a data signal.

In the case where a white gray scale value is expressed after a black gray scale is expressed, a pixel may generate light with a luminance lower than a desired luminance during about two frames. In this case, an image with a desired luminance is not displayed in each pixel. This may serve as a major factor that lowers the uniformity of the luminance of the display and that deteriorates the image quality of moving pictures.

The problem of lowering the response characteristics of the display device may be caused by the characteristics of the driving transistor in each pixel. In other words, the threshold voltage of the driving transistor may experience a shift corresponding to a voltage applied to the driving transistor in a previous frame. Consequently, light with a desired luminance is not generated in a current frame because of the shifted threshold voltage.

In one or more of the aforementioned embodiments, the driving transistor is initialized in the on-bias state before the data signal is supplied. Accordingly, it is possible to display an image with a desired luminance regardless of the data signal in the previous period. Further, the driving transistor can be initialized in the on-bias state by supplying a reference voltage to an emission control line without adding a separate transistor.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An organic light emitting display device, comprising:
a plurality of pixels at areas defined by intersections of scan lines, emission control lines, and data lines;
a data driver to supply data signals to the data lines; and
a scan driver to supply scan signals to the scan lines, and to progressively supply a reference power source voltage and an emission control signal to the emission control lines, the reference power source voltage set to a voltage greater than a voltage of the scan signal and less than a voltage of the emission control signal.

2. The display device as claimed in claim 1, wherein each pixel includes:
a plurality of transistors to receive the reference power source voltage from the scan driver, wherein the reference power source is to provide a voltage at a level to turn on a first transistor and to turn off a second transistor.

3. The display device as claimed in claim 1, wherein:
the scan driver is to progressively supply the scan signal to the scan lines,
the scan driver is to supply the reference power source voltage to a j-th emission control line to overlap the scan signal supplied to a (j−1)-th scan line during a first period, and
the scan driver is to supply the emission control signal to the j-th emission control line to overlap the scan signal supplied to the (j−1)-th scan line and the scan signal supplied to a j-th scan line during a second period which does not overlap the first period.

4. The display device as claimed in claim 3, wherein:
the scan driver includes a plurality of control transistors coupled to respective ones of the emission control lines, and
each control transistor is to supply the reference power source voltage to a respective emission control line based on a control signal.

5. The display device as claimed in claim 1, wherein each pixel positioned on a j-th horizontal line of the display device includes:
an organic light emitting diode (OLED);
a first transistor to control an amount of current flowing from a first power source coupled through a first node to a second power source via the OLED, corresponding to a voltage applied to a second node;
a fifth transistor coupled between the first power source and the first node, the fifth transistor having a gate electrode coupled to a j-th emission control line; and
a sixth transistor coupled between a second electrode of the first transistor and an anode electrode of the OLED, the sixth transistor having a gate electrode coupled to the j-th emission control line.

6. The display device as claimed in claim 5, wherein:
the fifth transistor is to turn on when the reference power source voltage is supplied to the j-th emission control line, and
the sixth transistor is to turn off when the reference power source voltage is supplied to the j-th emission control line.

7. The display device as claimed in claim 5, wherein the fifth and sixth transistors are to turn off when the emission control signal is supplied to the j-th emission control line.

8. The display device as claimed in claim 5, wherein each pixel includes:
a second transistor coupled between the second node and an initialization power source, the second transistor to turn on when the scan signal is supplied to a (j−1)-th scan line;
a third transistor coupled between the second electrode of the first transistor and the second node, the third transistor to turn on when the scan signal is supplied to a j-th scan line; and
a fourth transistor coupled between a data line and the first node, the fourth transistor to turn on when the scan signal is supplied to the j-th scan line.

9. The display device as claimed in claim 8, wherein the initialization power source is set to a voltage lower than a voltage of the data signal.

10. The display device as claimed in claim 8, wherein each pixel includes:
a seventh transistor coupled between the anode electrode of the OLED and the initialization power source, the seventh transistor to turn on when the scan signal is supplied to a (j+1)-th scan line.

11. The display device as claimed in claim 10, wherein the scan signal supplied to the (j+1)-th scan line overlaps the emission control signal supplied to the j-th emission control line.

12. A pixel circuit, comprising:
a first transistor coupled to a first power source; and
a second transistor coupled to a second power source,
wherein the first and second transistors are to turn on during a first period to initialize a driving transistor coupled to control an organic light emitting diode (OLED), the first transistor to turn on based on a first value of an emission control line and the second transistor is to turn on based on a first scan signal of another pixel circuit.

13. The pixel circuit as claimed in claim 12, further comprising:
a third transistor between the driving transistor and OLED,
wherein third transistor is to turn off based on the first value of the emission control line which is to turn on the first transistor during the first period.

14. The pixel circuit as claimed in claim 13, wherein the first transistor and the third transistor have a same conductivity type.

15. The pixel circuit as claimed in claim 14, wherein the first transistor is to turn on and the third transistor is to turn off based on the first value of the emission control line based on a coupling of the first transistor to the first power source during the first period.

16. The pixel circuit as claimed in claim 12, wherein the first and second transistors are to turn on to initialize the driving transistor before a data signal is received.

17. The pixel circuit as claimed in claim 12, wherein the first scan signal does not overlap a second scan signal applied to diode-connect the driving transistor.

18. The pixel circuit as claimed in claim 13, wherein:
the first transistor is to turn off based on a second value of the emission control line applied during a second period which does not overlap the first period.

19. The pixel circuit as claimed in claim 18, wherein the emission control line has the second value at a same time the first scan signal is applied to the other pixel circuit.

20. The pixel circuit as claimed in 12, further comprising:
a storage capacitor coupled between the first power source and the second transistor.
